(19) United States
(12) Patent Application Publication
(10) Pub. No.: US 2016/0140624 A1
(43) Pub. Date: May 19, 2016

(54) TRANSMITTING DEVICE, TRANSMITTING METHOD, NON-TRANSITORY INFORMATION RECORDING MEDIUM, AND PROGRAM

(71) Applicant: RAKUTEN, INC., Tokyo (JP)

(72) Inventor: Yuki FUKUDA, Tokyo (JP)

(73) Assignee: Rakuten, Inc., Tokyo (JP)

(21) Appl. No.: 14/904,900

(22) PCT Filed: Jun. 25, 2014
(86) PCT No.: PCT/JP2014/066803

§ 371 Date: Jan. 13, 2016

(51) Int. Cl. G06Q 30/02; H04L 29/08; G06Q 10/10; H04L 12/58

(52) U.S. Cl. CPC G06Q 30/0269; H04L 51/22; H04L 67/22; H04L 51/14; H04L 51/16; G06Q 10/107

(57) ABSTRACT

In an electronic mail transmitting device (100), a determiner (101) determines, based on a behavior history of the user, the number of e-mails to be transmitted to a user within a predetermined time period. A classifier (102) classifies multiple contents to be distributed to the user within the predetermined time period to groups of the number of e-mails determined by the determiner (101). A generator (103) generates, for each of the groups that are classified the multiple contents by the classifier (102), an e-mail from the contents classified into the groups. A transmitter (104) transmits the e-mail generated for each of the groups to the user within the predetermined time period.

### TECHNICAL FIELD

The present disclosure relates to a transmitting device, a transmitting method, a non-transitory information recording medium, and a program.

### BACKGROUND ART

Electronic mail transmitting devices are known which provide information to customers by transmitting electronic mail thereto. For example, Patent Literature 1 discloses an information providing server which extracts, based on information such as a credit card transaction history and a place of residence, advertisement information to be transmitted, and which transmits an electronic mail in which the extracted advertisement information is posted to a credit card user.

In addition, services are also known which distribute, to a customer, mail magazines in which the contents include sale information, the latest special topic, and the like are posted (see, for example, Patent Literature 2). According to such services, an e-mail magazine of a kind specified by the user is transmitted by electronic mail to an e-mail address specified by the user for distribution at a preset time schedule.

### CITATION LIST

### Patent Literature

Patent Literature 1: Unexamined Japanese Patent Application Kokai Publication No. 2010-231392

Patent Literature 2: Unexamined Japanese Patent Application Kokai Publication No. 2013-120443

### SUMMARY OF INVENTION

### Technical Problem

Advertisers transmit electronic mail containing an advertisement to customers in order to accomplish an advertisement effect. That is, the purposes of the advertiser is to provide new information to the customers by electronic mail, to cause the customer who views this new information to purchase the product of the advertiser, or to cause the customer to utilize the service of the advertiser, thereby getting a profit.

When, however, the customer receives too many e-mails, the customer sometimes leaves the e-mail messages unread. In addition, the possibility that the transmitted e-mails are deleted by a spam filter which determines that such e-mail messages are spam increases. When the transmitted advertisement e-mail is not read, the advertiser is unable to accomplish the advertisement effect.

In addition, when electronic mail that is not read is transmitted over the network, the network resource is wasted and consumed, and thus this situation is not desirable.

Hence, a technology of controlling the number of e-mails to be transmitted is strongly desired.

The present disclosure has been made in view of the above technical problems, and it is an objective of the present disclosure to provide a transmitting device, a transmitting method, a non-transitory recording medium, and a program which can control the number of e-mails to be transmitted according to the characteristics of an electronic mail transmission destination.

### Solution to Problem

In order to accomplish the above objective, a transmitting device according to a first aspect of the present disclosure includes:

a determiner that determines, based on a behavior history of a user, a number of e-mails to be transmitted to the user within a predetermined time period;

a classifier that classifies a plurality of contents to be distributed to the user within the predetermined time period into groups by what corresponds to the number of e-mails determined by the determiner;

a generator that generates, for each of the groups into which the plurality of contents are classified by the classifier, an e-mail with the content classified into each of the groups; and

a transmitter that transmits, to the user, the e-mail created for each of the groups within the predetermined time period.

The transmitting device of the first aspect may further include a calculator that calculates, based on the behavior history of the user, an interest level of the user to a provider of the content,

wherein the generator may set a transmission originator of the e-mail generated for each of the groups to be the provider with a highest calculated interest level among providers of the contents classified into the respective groups.

In the transmitting device of the first aspect, the generator may arrange, in the-mail generated for each of the groups, the contents classified into each of the groups in an order of the higher calculated interest level to the providers of the contents classified into the respective groups.

In the transmitting device of the first aspect, the classifier may select, by what corresponds to the determined number, the providers with a higher ranking calculated interest level among the providers of the contents, and classify the contents of the selected provider so as not to be redundant with one another into the groups by what corresponds to the determined number.

In the transmitting device of the first aspect, the interest level may be calculated based on a viewing behavior of the user who views a website managed by the provider of the contents within a threshold time period after the content is distributed to the user.

In the transmitting device of the first aspect, the interest level may be calculated based on a purchasing behavior of the user who purchases a product or a service from the provider of the contents within a threshold time period after the content is distributed to the user.

In the transmitting device of the first aspect, the calculator may further calculate a reaction level of the user to the e-mail based on the interest level calculated for the provider of the content contained in the e-mail transmitted to the user; and

the determiner may determine the number of e-mails so as to maximize an expectation value in the reaction level of the user to the e-mail to be transmitted to the user.

The transmitting device of the first aspect may further include a recorder that records the behavior history of the user, wherein:

the determiner may determine the number of e-mails to be transmitted to the user within the predetermined time period; and

the calculator may calculate the interest level of the user to each of the providers of the contents based on the behavior history of the user recorded in the recorder.

In order to accomplish the above objective, a transmitting method according to a second aspect of the present disclosure is performed by a transmitting device, and the method includes:

causing the transmitting device to determine, based on a behavior history of a user, a number of e-mails to be transmitted to the user within a predetermined time period;

causing the transmitting device to classify a plurality of contents to be distributed to the user within the predetermined time period into groups by what corresponds to the determined number of e-mails;

causing the transmitting device to generate, for each of the groups by what corresponds to the determined number, an e-mail with the content classified into each of the groups; and

causing the transmitting device to transmit, to the user, the e-mail generated for each of the groups within the predetermined time period.

In order to accomplish the above objective, a non-transitory computer readable information recording medium according to a third aspect of the present disclosure has stored therein a program that causes a computer to function as:

a determiner that determines, based on a behavior history of a user, a number of e-mails to be transmitted to the user within a predetermined time period;

a classifier that classifies a plurality of contents to be distributed to the user within the predetermined time period into groups by what corresponds to the determined number of e-mails;

a generator that generates, for each of the groups by what corresponds to the determined number, an e-mail with the content classified into each of the groups; and

a transmitter that transmits, to the user, the-mail generated for each of the group within the predetermined time period.

In order to accomplish the above objective, a program according to a fourth aspect of the present disclosure causes a computer to function as:

a determiner that determines, based on a behavior history of a user, a number of e-mails to be transmitted to the user within a predetermined time period;

a classifier that classifies a plurality of contents to be distributed to the user within the predetermined time period into groups by what corresponds to the determined number of e-mails;

a generator that generates, for each of the groups by what corresponds to the determined number, an e-mail with the content classified into each of the groups; and

a transmitter that transmits, to the user, the e-mail generated for each of the group within the predetermined time period.

### Advantageous Effects of Invention

According to the transmitting device, transmitting method, non-transitory information recording medium, and program of the present disclosure, an advertisement effect by electronic mail can be accomplished more effectively.

### BRIEF DESCRIPTION OF DRAWINGS

FIG. 1 is a block diagram illustrating a functional structure of an electronic mail transmitting device according to a first embodiment;

FIG. 2 is a block diagram illustrating a hardware structure of the electronic mail transmitting device according to the first embodiment;

FIG. 3 is a flowchart of a contents distributing process according to the first embodiment;

FIG. 4 is a flowchart of a number of e-mails determining step according to the first embodiment;

FIG. 5 is a flowchart of a contents classifying step;

FIG. 6 is a block diagram illustrating a functional structure of an electronic mail transmitting device according to a second embodiment;

FIG. 7 is a flowchart of a contents distributing process according to the second embodiment;

FIG. 8 is a flowchart of a behavior history recording step;

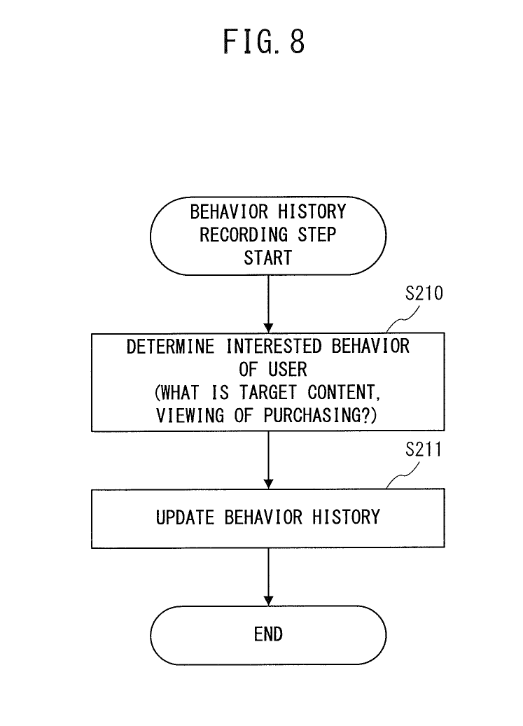

FIG. 9 is a diagram illustrating an example behavior history log;

FIG. 10 is a flowchart of an interest level calculating step;

FIG. 11 is a diagram illustrating an example interest level history table;

FIG. 12 is a flowchart of a number of e-mails determining step according to the second embodiment;

FIG. 13 is a flowchart of a number of e-mails determining step according to a third embodiment;

FIG. 14 is a diagram illustrating an example interest level history table;

FIG. 15 is a diagram illustrating a credit card user database according to a fourth embodiment; and

FIG. 16 is a diagram illustrating a contents database according to the fourth embodiment.

### DESCRIPTION OF EMBODIMENTS

Embodiments of the present disclosure will be explained below with reference to the accompanying figures.

### First Embodiment

An electronic mail transmitting device 100 according to a first embodiment of the present disclosure has a function of transmitting, to users specified beforehand, electronic mail that contains multiple contents like advertisements. In addition, the electronic mail transmitting device also has a function of dividing the multiple contents to be transmitted into a number of e-mails determined based on a past behavior history of the target user, and of transmitting those-mails.

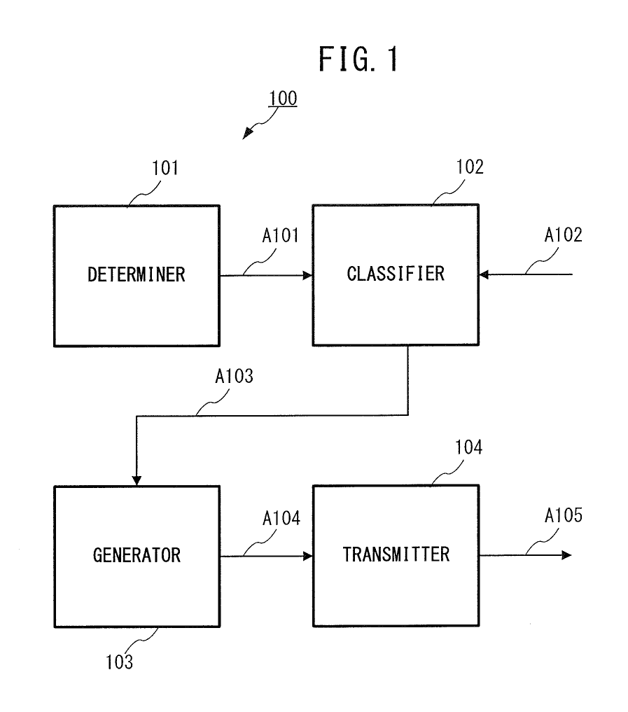

As illustrated in FIG. 1, the electronic mail transmitting device 100 of this embodiment includes, as functions, a determiner 101, a classifier 102, a generator 103, and a transmitter 104.

The determiner 101 determines, based on a history indicating what behavior the user who received electronic mail in the past transmitted by the electronic mail transmitting device 100 took, the number of e-mails to be transmitted within a predetermined time period. The determiner 101 outputs (A101) the determined number of e-mails.

The classifier 102 classifies the multiple contents to be distributed to the user by the electronic mail transmitting device 100 within a predetermined time period into groups by what corresponds to the number of e-mails determined by the determiner 101. When, for example, 35 contents from a content 1 to a content 35 are to be transmitted to the target user within five days, and when the determiner 101 determines that the number of e-mails to be transmitted is six, the classifier 102 classifies the contents 1 to 6 into a first group, the contents 7 to 12 into a second group, the contents 13 to 18 into a third group, the contents 19 to 24 into fourth group, the contents 25 to 30 into a fifth group, and the contents 31 to 35 into a sixth group, respectively.

The classifier 102 receives (A102) inputting of the multiple contents, receives (A101) the number of e-mails determined by the determiner 101, and outputs (A103) the respective groups into which the contents are classified.

The generator 103 generates an e-mail based on the content classified into each group by the classifier 102. When, for example, the classifier 102 classifies the content 1 and the content 2 into a group, the generator 103 generates an electronic mail which has the body of the-mail containing the content 1 and the content 2, and which also has the transmission destination that is the e-mail address corresponding to the directed user.

The generator 103 receives (A103) inputting of the contents classified by the classifier 102, and outputs (A104) the generated electronic mail.

The transmitter 104 transmits (A105) the-mail generated by the generator 103 to the directed user within a predetermined time period.

The electronic mail transmitting device 100 that employs the above structure distributes, for example, the 35 contents from the content 1 to the content 35 through six electronic mails. By distributing the contents through the smaller number of e-mails than the number of contents, the electronic mail transmitting device 100 is capable of reducing the number of e-mails to be transmitted. In addition, the electronic mail transmitting device 100 controls the number of e-mails to be transmitted in a desired number according to the behavior history of the user. Hence, the electronic mail transmitting device 100 is capable of enhancing the advertisement effect of the e-mails to be transmitted.

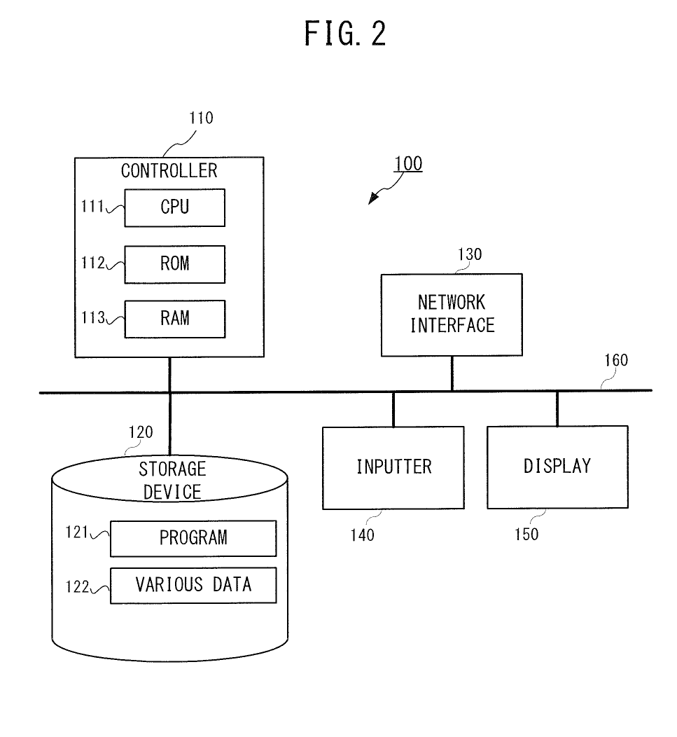

As illustrated in FIG. 2, the electronic mail transmitting device 100 includes, as hardware resources, a controller 110, a storage device 120, a network interface 130, an inputter 140, and a display 150, and those components are connected to one another via a bus 160.

The controller 110 includes a CPU (Central Processing Unit) 111, a ROM (Read Only Memory) 112, and a RAM (Random Access Memory) 113.

The CPU 111 reads a program from the ROM 112 or the storage device 120, and executes the read program. The ROM 112 stores a necessary program to operate the CPU 111. The RAM 113 temporarily stores data to be processed when the CPU 111 executes the program, and functions as a so-called work area.

The CPU 111, the ROM 112, and the RAM 113 work and function together as explained above, and thus the controller 110 controls the whole electronic mail transmitting device 100.

The storage device 120 includes a non-volatile storage device, such as a hard disk drive, a flash memory, or an SSD (Solid State Drive), and stores necessary data to operate the electronic mail transmitting device 100. The storage device 120 contains, for example, an area that stores a program 121 to be executed by the CPU 111, or records various pieces of data 122 necessary to distribute the contents (for example, contents data, information indicating the directed user, and information indicating the behavior history of the user).

The network interface 130 connects the electronic mail transmitting device 100 with a network (unillustrated). When the electronic mail transmitting device 100 transmits information to another device or receives information from another device via the network, the network interface 130 transmits, to another device via the network, information received from the controller 110 through the bus 160 to be explained later, or transmits, to the controller 110 via the bus 160, information received from another device through the network.

The network interface 130 may connect the electronic mail transmitting device 100 with the network via, for example, a cable, or may connect the electronic mail transmitting device 100 via, for example, wireless communication.

The inputter 140 includes a mouse, a keyboard, and the like, accepts an input manipulation given by a manipulating user, and transmits the input detail to the controller 110.

The display 150 includes, for example, a liquid crystal display, and displays information output by the controller 110 for the manipulating user.

When manipulating the electronic mail transmitting device 100 of this embodiment, the manipulating user manipulates the electronic mail transmitting device through the inputter 140 while viewing information displayed on the display 150. However, the present disclosure is not limited to this form. Since the electronic mail transmitting device 100 is connected with the network via the network interface 130, the manipulating user is allowed to view information from the electronic mail transmitting device 100 via the network, and to manipulate the electronic mail transmitting device 100 through the network. When the electronic mail transmitting device 100 is fully functional via the network, the electronic mail transmitting device 100 may have no inputter 140 and display 150.

The bus 160 relays information exchange among structural components (the controller 110, the storage device 120, the network interface 130, the inputter 140, the display 150, and the like) in the electronic mail transmitting device 100. When, for example, the controller 110 reads the necessary data from the storage device 120, the controller 110 reads the data from the storage device 120 through the bus 160.

The controller 110 functions as components (the determiner 101, the classifier 102, the generator 103, and the transmitter 104) that realize the above respective functions. The details will be explained later.

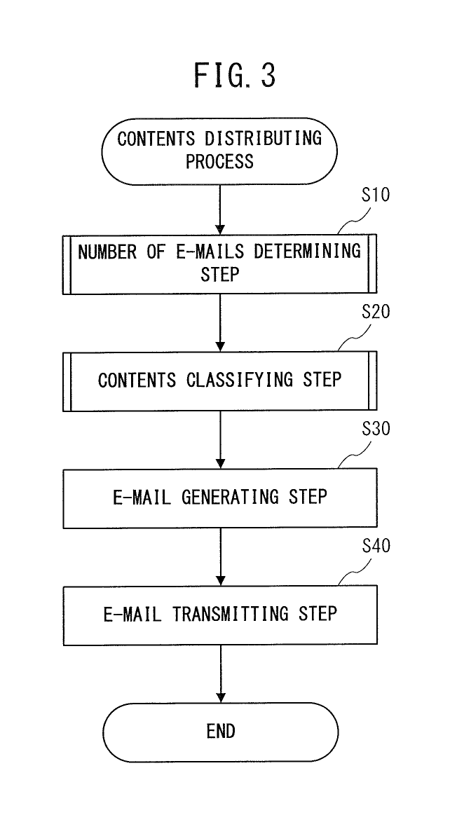

The electronic mail transmitting device 100 executes, for each predetermined time period, a contents distributing process illustrated in FIG. 3, and transmits multiple contents to the user by electronic mail. As illustrated in FIG. 3, the contents distributing process includes a number of e-mails determining step S10, a contents classifying step S20, an e-mail creating step S30, and an e-mail transmitting step S40. The components that realize the above respective functions (the determiner 101, the classifier 102, the generator 103, and the transmitter 104) execute processes corresponding to the above respective steps (number of e-mails determining step S10, contents classifying step S20, mail creating step S30, and mail transmitting step S40). That is, the determiner 101 executes the process corresponding to the number of e-mails determining step S10. Likewise, the classifier 102, the generator 103, and the transmitter 104 execute the processes corresponding to the contents classifying step S20, the-mail creating step S30, and the-mail transmitting step S40, respectively.

Each of the above steps will be explained below in more detail.

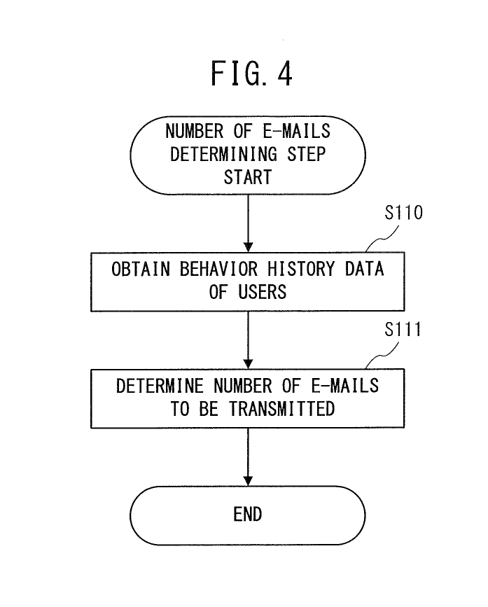

As illustrated in FIG. 4, the number of e-mails determining step S10 includes step S110 and step S111 explained below.

At the beginning of the number of e-mails determining step S10, the controller 110 obtains (step S110) the behavior history of the user. Information indicating the behavior history of the user is recorded in the storage device 120, and contains, for example, the content viewed by the user in the past and the number of viewings thereof, the purchased product and the number of purchases thereof, the utilized service and the number of utilizations thereof, or into how many mails the contents were classified and transmitted when the-mails were transmitted in the past to that user.

Next, the controller 110 determines (step S111) the number of e-mails to be transmitted to the target user based on the information indicating the behavior history of the user and obtained in step S110. When, for example, the information indicating the behavior history of the user contains information indicating that, when the contents were classified into a larger number of e-mails and transmitted to the target user, the number of views of the contents was large, the controller 110 determines a larger number of e-mails to be transmitted to the target user. Conversely, when the information indicating the behavior history of the user contains information indicating that, although the contents were classified into a larger number of e-mails and transmitted, the number of views of the contents was small, the controller 110 determines a smaller number of e-mails to be transmitted to the user.

The controller 110 records the determined number of e-mails to be transmitted in the area of a storage device 120 which stores information about the directed user, and ends the number of e-mails determining step S10. The controller 110 that executes the number of e-mails determining step S10 functions as the determiner 101.

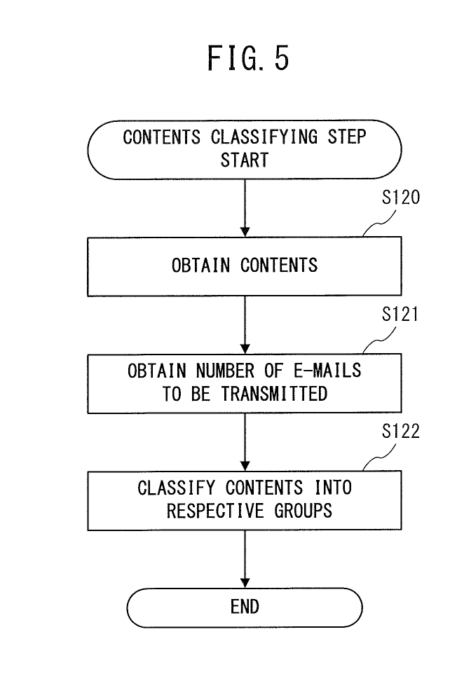

When the number of e-mails determining step S10 ends, the controller 110 executes, at a predetermined time point within the predetermined time period, the contents classifying step S20 illustrated in FIG. 5.

At the beginning of the contents classifying step S20, the controller 110 obtains (step S120) contents data representing the multiple contents to be distributed to the user. The controller 110 reads the contents data from the storage device 120, thereby obtaining the contents to be distributed.

Next, the controller 110 reads (step S121), from the area of the storage device 120 which stores the directed user information, the number of e-mails to be transmitted and determined through the number of e-mails determining step S10.

Subsequently, the controller 110 classifies (step S122) the multiple contents to be transmitted to the user into the groups by what corresponds to the number of e-mails to be transmitted and read in step S121.

More specifically, when, for example, the total of 35 contents from the content 1 to the content 35 are to be transmitted to the target user, and when the number of e-mails to be transmitted is determined as six through the number of e-mails determining step S10, the contents 1 to 6, the contents 7 to 12, the contents 13 to 18, the contents 19 to 24, the contents 25 to 30, and the contents 31 to 35 are classified into the first group, the second group, the third group, the fourth group, the fifth group, and the six group, respectively. At this time, the controller 110 classifies the contents based on a predetermined reference. As explained above, the controller 110 functions as the classifier 102.

The controller 110 records the groups into which contents are classified in the storage device 120, and ends the contents classifying step S20.

When the contents classifying step S20 ends, next, the controller 110 generates (mail creating step S30) mails based on the respective groups into which the contents are classified.

When, for example, the content 1 and the content 2 are classified into the first group, the controller 110 generates, starting from the first group, an e-mail that has a body of the-mail containing the content 1 and the content 2. In addition, the controller 110 reads the e-mail address of the transmission target user from the area of the storage device 120 which stores information indicating the directed user, and sets the read e-mail address as the directed address of the generated mail. Still further, the controller 110 sets, based on a predetermined reference, the transmission originator address of the generated mail, and the title of this mail. As explained above, the controller 110 generates the-mail to be transmitted to the directed user based on each group into which the content is classified through the contents classifying step S20. As explained above, the controller 110 functions as the generator 103.

Next, the controller 110 transmits (mail transmitting step S40) the-mail generated through the-mail creating step S30. The controller 110 functions as a general mail server, and transmits, to the connected network through the network interface 130, the generated mail. As explained above, the controller 110 functions as the transmitter 104.

When the-mail is transmitted through the-mail transmitting step S40, the controller 110 ends the contents distributing process.

As explained above, the electronic mail transmitting device 100 of this embodiment determines the number of electronic mails to be transmitted according to the behavior history of the user. Hence, the electronic mail transmitting device 100 is capable of transmitting an appropriate number of electronic mails to the directed user, thereby accomplishing a more effective advertisement effect.

### Second Embodiment

An electronic mail transmitting device 200 according to a second embodiment of the present disclosure has a function of periodically distributing, to the user, the multiple contents registered by the user beforehand in the form of an e-mail magazine by electronic mail. The electronic mail transmitting device 200 divides the multiple scheduled contents to be distributed within a predetermined time period into the number of e-mails determined based on the past behavior history of the target user. The electronic mail transmitting device 200 receives, from a provider of contents, the contents that the provider of the contents wants to distribute to the user, and distributes the received contents to the user.

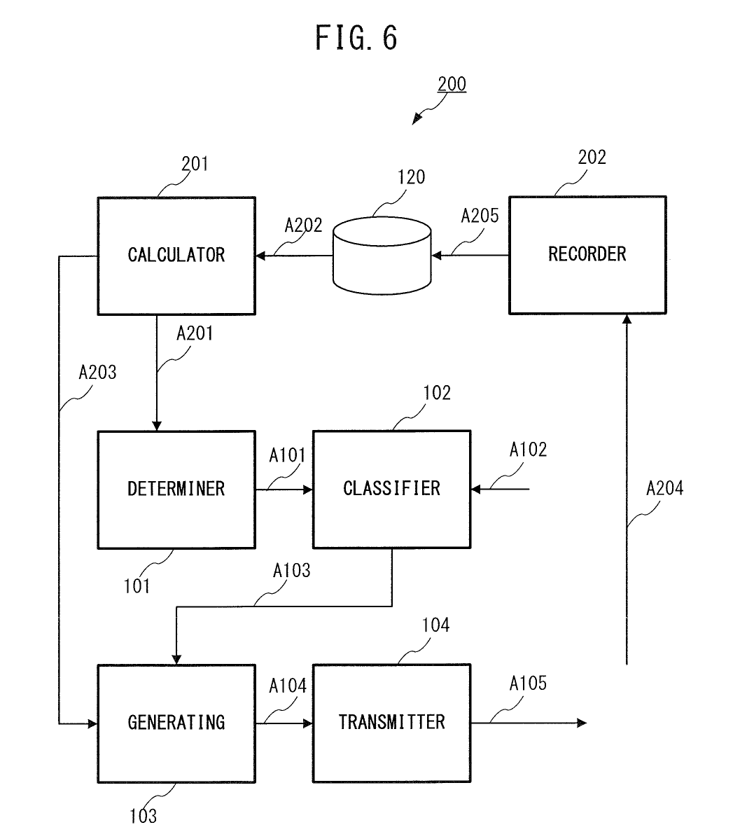

As illustrated in FIG. 6, the electronic mail transmitting device 200 includes, as functions, the determiner 101, the classifier 102, the generator 103, the transmitter 104, a calculator 201, and a recorder 202. In those components, the classifier 102 and the transmitter 104 are the same as those of the electronic mail transmitting device 100 of the first embodiment. Hence, the explanation thereof will be omitted.

The calculator 201 obtains (A202), from the storage device 120, the behavior taken by the directed user for each content contained in an e-mail transmitted in the past thereto, and calculates an interest level of the user to each of the provider of the contents. More specifically, the calculator 201 reads, from the storage device 120, how many times the user to whom the-mail containing the target content was transmitted viewed a website which handles the target content within a predetermined time period after the transmission of the-mail, or how many times that user purchased a product or a service relevant to the content 1, or a purchase amount, and calculates the interest level of the user to the content 1 based on those pieces of information. When, for example, this is a first time that the directed user is added to the address, and no mail had been transmitted to this transmission destination user in the past, the calculator 201 sets, for example, the interest level to the target content to be a prescribed numerical value, and thus defining the interest level according to a predetermined reference.

When, for example, the storage device 120 records information indicating that the user to whom an e-mail containing the content 1 and the content 2 was transmitted viewed a website which handles information on the content 1 several times but did not view a website which handles information on the content 2 after the transmission of the-mail, the calculator 201 calculates a higher interest level of the user to the provider of the content 1 than an interest level to the provider of the content 2.

The calculator 201 outputs (A201 and A203) the calculated interest level of the user to the provider of each content.

The recorder 202 detects (A204) the behavior taken by the user to whom the-mail was transmitted from the transmitter 104 for each content contained in the-mail within a threshold time period after the-mail was transmitted, and records (A205) the detected behavior in the storage device 120. When, for example, the user to whom an e-mail containing the content 1 was transmitted viewed a website that handles information on the content 1 within the threshold time period after the transmission of the-mail, information to the effect that the user viewed the website handling the information on the content 1 within the threshold time period is recorded. Alternatively, when the user to whom the-mail containing the content 1 was transmitted purchased a product or a service relevant to the content 1 within the threshold time period after the transmission of the-mail, information to the effect that the user purchased the product or the service relevant to the content 1 within the threshold time period is recorded together with the purchase amount.

The determiner 101 determines the number of e-mails to be transmitted within a predetermined time period based on the interest level (A201) of the user to the provider of each content calculated by the calculator 201, and outputs (A101) the determined number of transmission mails.

The generator 103 generates and outputs (A104) an electronic mail based on the content (A103) classified into each group by the classifier 102, and the interest level (A203) of the user to the provider of each contents calculated by the calculator 201.

The electronic mail transmitting device 200 includes, like the hardware structure of the electronic mail transmitting device 100 illustrated in FIG. 2, the controller 110, the storage device 120, the network interface 130, and the inputter 140 and the display 150, and those components are connected to one another via the bus 160. All structural components are the same as those of the electronic mail transmitting device 100, and thus the explanation thereof will be omitted.

The controller 110 functions as components (the determiner 101, the classifier 102, the generator 103, the transmitter 104, the calculator 201, and the recorder 202) that realize the above respective functions. The details will be explained later.

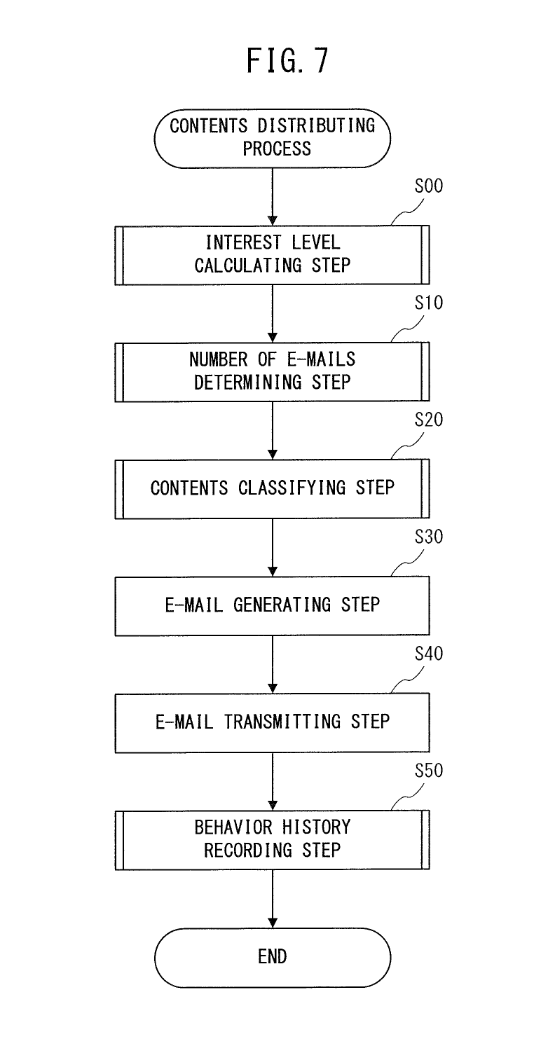

The electronic mail transmitting device 200 of this embodiment executes a contents distributing process illustrated in FIG. 7 for each predetermined time period, and transmits the multiple contents to the user by electronic mail. As illustrated in FIG. 7, the contents distributing process includes an interest level calculating step S00, the number of e-mails determining step S10, the contents classifying step S20, the-mail creating step S30, the-mail transmitting step S40, and a behavior history recording step S50. In comparison with the contents distributing process of the first embodiment, according to this embodiment, the interest level calculating step S00 and the behavior history recording step S50 are added to the contents distributing process.

The components that realize the above respective functions (the calculator 201, the determiner 101, the classifier 102, the generator 103, the transmitter 104, and the recorder 202) execute processes corresponding to the above respective steps (interest level calculating step S00, number of e-mails determining step S10, contents classifying step S20, mail creating step S30, mail transmitting step S40, and behavior history recording step S50). This is the same as the first embodiment, and the calculator 201, the determiner 101, the classifier 102, the generator 103, the transmitter 104, and the recorder 202 executes processes corresponding to the interest level calculating step S00, the number of e-mails determining step S10, the contents classifying step S20, the-mail creating step S30, the-mail transmitting step S40, and the behavior history recording step S50, respectively.

Each of the above steps will be explained below in more detail.

First, the behavior history recording step S50 that is the last step in the contents distributing process will be explained. The behavior history recording step S50 is a step of recording the behavior history of the user after the contents are distributed, and includes a process of recording the behavior history that will be a reference for the interest level calculating step S00 in the next contents distributing process.

When the user accesses the website that handles the contents within the threshold time period after the contents are distributed to the user, or when the user purchases a product or a service relevant to the content after the distribution of the content, the electronic mail transmitting device 200 records the behavior of the user as a history through the behavior history recording step S50. In the following explanation, the behavior of the user showing an interest to the content will be referred to as an interested behavior, and the interested behavior includes activities such that the user views the website that handles the contents, and the user purchases a product or a service relevant to the content.

At the beginning of the behavior history recording step S50, the controller 110 determines (step S210) what is the interested behavior of the user. When, for example, the user views the website that handles the content 1, the controller 110 determines that the interested behavior of the user for the “content 1” is to “view”. In addition, when, for example, the user purchases a product relevant to the content 2, the controller 110 determines that the interested behavior of the user for “content 2” is to “purchase”.

Next, the controller 110 updates (step S211) the behavior record of the user. More specifically, the controller 110 updates information (behavior history log) indicating the behavior history of the user and recorded in the storage device 120, and records the date and hour at which the user took the interested behavior, and the detail of the interested behavior determined in step S210. When, for example, the user viewed the website that handles the content 1, the controller 110 records the date and hour at which the user viewed the website that handles the content 1, information indicating that the target content was the content 1, and information indicating that the kind of behavior was to view. In addition, when, for example, the user purchased the product relevant to the content 2, the controller 110 records the purchase date and hour, information indicating that the target content was the content 2, information indicating that the kind of behavior was to purchase, and information on the purchase amount by the user.

After step S211 ends, the controller 110 ends the behavior history recording step S50. The controller 110 that executes the behavior history recording step S50 functions as the recorder 202.

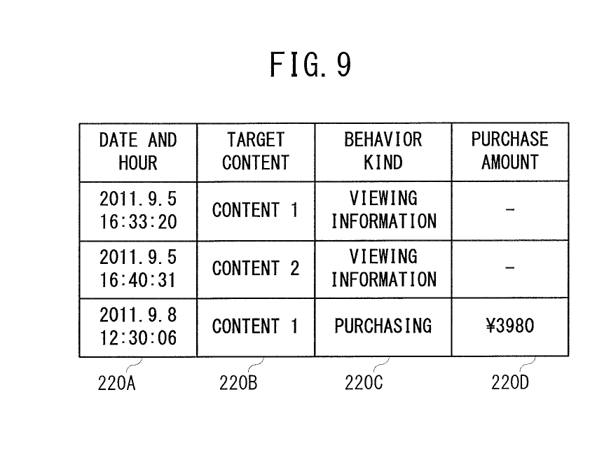

When the user takes the interested behavior within a predetermined time period after the contents are distributed to the user, the electronic mail transmitting device 200 records the interested behavior in the behavior history log through the above behavior history recording step S50. As illustrated in FIG. 9, the electronic mail transmitting device 200 individually records, in the behavior history log, the date and hour at which the interested behavior was taken (220A), the target content (220B), the behavior kind (220C), and the purchase amount (220D) when the kind of behavior was to purchase.

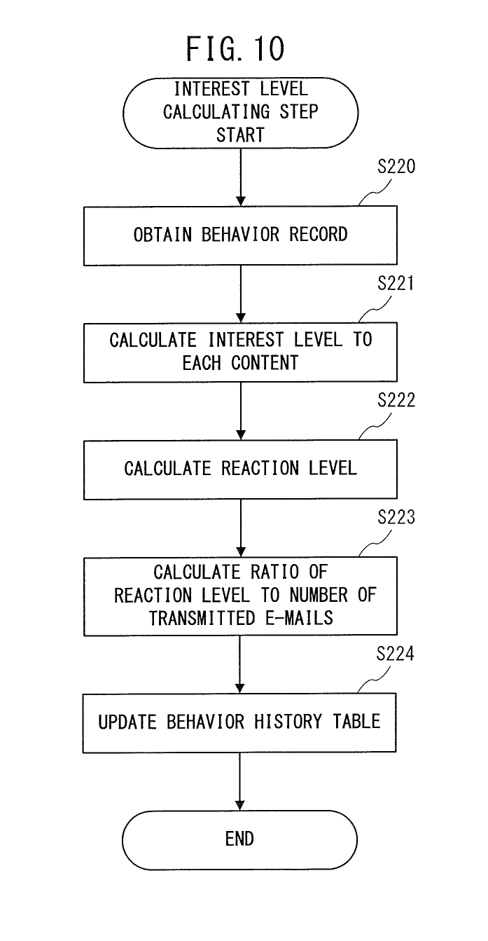

In addition, the electronic mail transmitting device 200 executes, at the beginning of the contents distributing process, the interest level calculating step S00 illustrated in FIG. 10. In the interest level calculating step S00, the behavior history log recorded through the behavior history recording step S50 of the past contents distributing process, the behavior history is tallied up, and the calculated interest level and a reaction level are recorded in an interest level history table.

At the beginning of the interest level calculating step S00, the controller 110 obtains (step S220), from the storage device 120, the behavior history of the user recorded through the behavior history recording step S50 of the past contents distributing process. The electronic mail transmitting device 200 of this embodiment calculates, month by month, the interest level based on the interested behavior taken in the last month, and thus the controller 110 reads information on the interested behavior taken in the last month.

Next, the controller 110 calculates (step S221) the interest level to the provider of each content based on the obtained behavior record. For example, based on a predetermined reference, the controller 110 calculates the interest level of the target user to each content according to how many times the target user viewed the website relevant to each content within a target time period, and how many times the user purchased the product or the service relevant to each content, or the purchase amount, and the like.

For example, it is assumed that such a reference is given with a setting made so as to add a value 10 to the interest level every time the website relevant to the content is viewed, and a value 50 to the interest level every time the product or the service relevant to the content is purchased. In this case, when, for example, the read behavior history log contains information recording the viewing twice and information recording the purchase once, the controller 110 calculates the total interest level of the target user to the provider of the target content as 70 since viewing twice×interest level 10+purchase once×interest level 50. The controller 110 executes the calculation of the interest level through this procedure for each contents contained in the transmitted e-mail.

Next, the controller 110 totals the interest level to the respective providers of the contents calculated in step S221, and calculates (step S222) the reaction level of the user. When, for example, the contents contained in the-mail transmitted to the target user was three that are the content 1 to the content 3, and the interest level of the user in step S221 in this month is calculated as 70 for the content 1, 30 for the content 2, and 10 for the content 3, the controller 110 totals those values, and calculates the reaction level of the target user that is 110.

Subsequently, the controller 110 calculates (step S223) the ratio of the reaction level to the number of e-mails transmitted to the target user in this month. When, for example, two mails were transmitted to the target user in this month, and the reaction level of the user in this month is 110, based on 110÷2=55, the controller 110 calculates the ratio of the reaction level to the number of e-mails transmitted to the target user in this month which is 55.

Next, the controller 110 records (step S224) the value calculated in step S221 to step S223 in the interest level history table. More specifically, the controller 110 records, in the interest level history table, information indicating the target time period, the number of e-mails transmitted to the user in the target time period, the reaction level calculated in step S222, the ratio of the reaction level to the number of e-mails calculated in step S223, and the interest level to each content calculated in step S221.

After step S224, the controller 110 ends the interest level calculating step S00. The controller 110 that executes the interest level calculating step S00 functions as the calculator 201 that calculates the interest level.

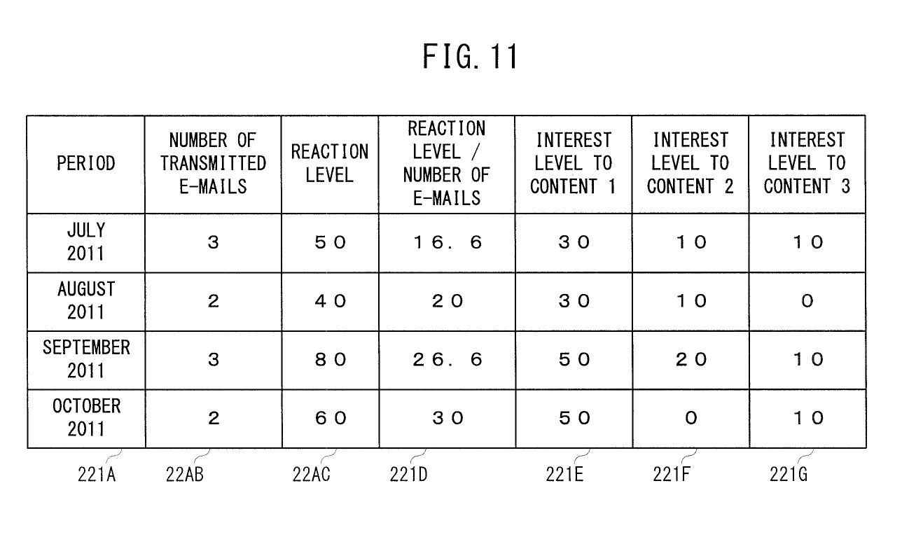

Through the interest level calculating step S00 explained above, the electronic mail transmitting device 200 records each piece of information illustrated in FIG. 11 in the interest level history table. That is, the electronic mail transmitting device 200 records, in the interest level history table, information (221A) indicating the time period at which the behavior history was recorded, information (221B) indicating the number of e-mails transmitted to the user within the target time period, information (221C) indicating the reaction level within the target time period, information (221D) indicating the ratio of the reaction level relative to the number of e-mails transmitted within the target time period (that is, the reaction level per e-mail), information (221E) indicating the interest level to each content within the target time period, and the like.

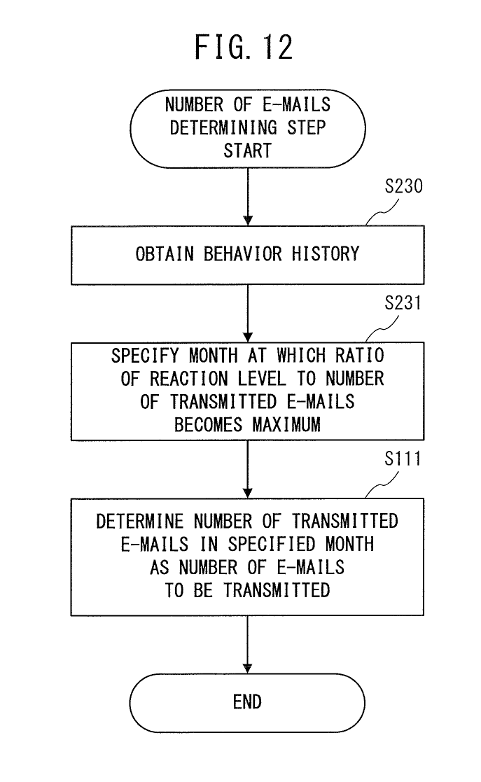

After completing the interest level calculating step S00, the electronic mail transmitting device 200 executes the number of e-mails determining step S10 illustrated in FIG. 12. An explanation will be given below of the number of e-mails determining step S10 according to this embodiment with reference to FIG. 12.

At the beginning of the number of e-mails determining step S10, the controller 110 refers to the interest level history table, and obtains (step S230) information indicating the behavior history of the user.

Next, the controller 110 specifies (step S231), based on the recorded detail in the interest level history table, a time period at which the ratio of the reaction level to the number of e-mails (for example, a total interest level) becomes the maximum. More specifically, when the interest level history table records data illustrated in FIG. 11, the controller 110 specifies that the time period at which the ratio of the reaction level relative to the number of e-mails becomes the maximum is the period of October 2011.

Subsequently, the controller 110 determines (step S111) the number of transmitted e-mails within the specified time period as the number of e-mails to be transmitted within the predetermined time period. As an example, in the case of the data illustrated in FIG. 11, since two mails were transmitted to the target user in the period of October 2011 that is the specified time period in step S231, the controller 110 determines that the number of e-mails to be transmitted is two.

The controller 110 records the determined number of classifications for the contents to be transmitted in the area of the storage device 120 which stores the directed user information, and ends the number of e-mails determining step S10. The controller 110 that executes the number of e-mails determining step S10 functions as the determiner 101.

Through the above number of e-mails determining step S10, the electronic mail transmitting device 200 determines the number of e-mails to be transmitted.

When completing the number of e-mails determining step S10, the electronic mail transmitting device 200 subsequently executes the-mail creating step S30, and then executes the-mail transmitting step S40, thereby distributing the contents to the user. The-mail creating step S30 and the-mail transmitting step S40 are the same as those of the first embodiment, and thus the explanation thereof will be omitted.

In addition, when completing the-mail transmitting step S40, the electronic mail transmitting device 200 executes the above behavior history recording step S50, and records the behavior record of the user. Subsequently, after a threshold time period has elapsed since the distribution of the contents, the electronic mail transmitting device 200 completes the behavior history recording step S50, and ends the contents distributing process.

As explained above, the electronic mail transmitting device 200 of this embodiment controls the number of e-mails to be transmitted according to the behavior history of the directed user like the electronic mail transmitting device 100 of the first embodiment. Hence, the electronic mail transmitting device 200 is capable of transmitting mails to the directed user in a manner divided into an appropriate number, and thus more effective advertisement effect is accomplished.

In addition, the electronic mail transmitting device 200 of this embodiment analyzes the interest level of the user to the provider of each content, and records the analyzed interest level. In this case, the electronic mail transmitting device 200 is capable of setting, by utilizing the recorded interest level, the e-mail address corresponding to the provider of the contents that has the highest interest level to be the-mail transmission originator in each mail when transmitting electronic mails, and then transmits this electronic mail.

When, for example, an e-mail that contains the content 1 and the content 2 is to be transmitted, and when the content 1 has the higher interest level of the user to the provider than the interest level of the content 2, the electronic mail transmitting device 200 may set the e-mail address of the provider of the content 1 as the transmission originator of the-mail. In this case, the electronic mail transmitting device 200 posts the content 1 to the header of the body of the-mail. The user to whom the-mail generated in such a way is transmitted can easily determine that this mail is from the provider of the content 1 to which this user is giving a high interest, and can view the content 1 immediately after opening the-mail. According to this structure, the possibility that the user reads the-mail increases, and thus the advertiser can expect a higher advertisement effect.

Still further, in recent years, users often utilize a spam filter, and when too many e-mails are transmitted from the same transmission originator, the spam filter may automatically delete the-mails from the same transmission originator.

As explained above, the electronic mail transmitting device 200 sets the e-mail address of the provider of the content to which the user gives a high interest among the contents contained in the-mail as the transmission originator, and the number of e-mails to be transmitted from the same transmission originator is limited (for example, only an e-mail within a predetermined time period). Hence, the electronic mail transmitting device 200 is capable of preventing the transmitted e-mails from being deleted by the spam filter at the user's end, and of increasing the possibility that the user views the target e-mails. In view of this point, also, the electronic mail transmitting device 200 is capable of maintaining a high advertisement effect of the contents to be distributed.

Yet still further, the electronic mail transmitting device 200 is also capable of arranging the sequence of the contents in the body of the-mail in the order of a higher interest level to the provider of the contents when creating the-mail that contains multiple contents. According to this structure, the user can view the contents in the order of the provider of the contents to which the user is giving a higher interest. Since the user friendliness improves, the possibility that the user views the-mail increases, and thus the provider of the contents can expect a higher advertisement effect.

In addition, the electronic mail transmitting device 200 classifies the multiple contents to be transmitted to the user into the groups by what corresponds to the number of e-mails to be transmitted, but the reference for classification is optional.

For example, the electronic mail transmitting device 200 may extract the same number of contents as the number of e-mails to be transmitted in the order of a higher interest level of the user to the provider of the contents among the multiple contents to be transmitted to the user, and may classify the extracted contents one by one in each group. In this case, when, for example, there are five contents (A, B, C, D, and E) to be transmitted, and when the number of e-mails to be transmitted is three, the electronic mail transmitting device 200 extracts, from the five contents to be transmitted, three contents with higher interests (for example, A, B, and C), and classifies A, B, and C into the first group, the second group, and the third group, respectively. In addition, the electronic mail transmitting device 200 sets the transmission originator address of the e-mail generated from the first group, the transmission originator address of the e-mail generated from the second group, and the transmission originator address of the e-mail generated from the third group to be the provider of the content A, the provider of the content B, and the provider of the content C, respectively, and, transmits the respective e-mails. The electronic mail transmitting device 200 adds the contents D and E that have a relatively low interest to any mail based on an arbitrary reference.

As explained above, the electronic mail transmitting device 200 classifies the content from the provider of the contents to which the user is giving a high interest level into each mail, and sets the e-mail address of the provider of the contents to which the user is giving a high interest level as the transmission originator address. This increases the possibility that the user views each mail. Hence, according to such a reference for classification, the electronic mail transmitting device 200 is capable of further enhancing the advertisement effect of each mail.

In addition, the electronic mail transmitting device 200 of this embodiment distributes the contents month by month, and calculates the interest level also month by month. However, the cycle of distributing the contents and of calculating the interest level is not limited to a monthly basis, and can be set freely. For example, the electronic mail transmitting device 200 may execute the above processes at an arbitrary interval, such as day by day, week by week, every two weeks, every 10 days, or every two months.

Still further, according to this embodiment, the electronic mail transmitting device 200 multiples the number of views and the number of purchases by respective multiplying factors based on the predetermined reference, and totals the obtained values to calculate the interest level to each content. However, such a reference is not limited to this form. For example, the electronic mail transmitting device 200 may calculate the interest level based on only the viewing behavior of the user who views a website provided by the provider of the contents within a threshold time period after the contents are distributed to the user. Alternatively, the electronic mail transmitting device 200 may calculate based on only the purchase behavior of the user who purchases the product or the service from the provider of the contents within a threshold time period after the contents are distributed to the user. Still further, the electronic mail transmitting device 200 may calculate the interest level based on the purchase amount by the user.

In the number of e-mails determining step S10, the electronic mail transmitting device 200 specifies a month at which the ratio of the reaction level to the number of transmitted e-mails becomes the maximum based on the recorded details in the interest level history table. At this time, the electronic mail transmitting device 200 may not refer to the whole interest level history table but to the interest level history table with a limited time period, such as referring to only the past 12 months.

### Third Embodiment

An electronic mail transmitting device 300 of this third embodiment transmits, like the electronic mail transmitting device 200 of the second embodiment, the multiple contents to be distributed to the user within a predetermined time period in a manner divided into multiple-mails by what corresponds to the determined number based on the past behavior history of the target user. In particular, the electronic mail transmitting device 300 determines the number of e-mails so as to maximize an expectation value in the reaction level of the user to the-mail to be transmitted to the user based on the behavior history of the user.

The electronic mail transmitting device 300 employs substantially the same hardware structure and functional structure as those of the electronic mail transmitting device 200 of the second embodiment, and thus only the differences will be explained below.

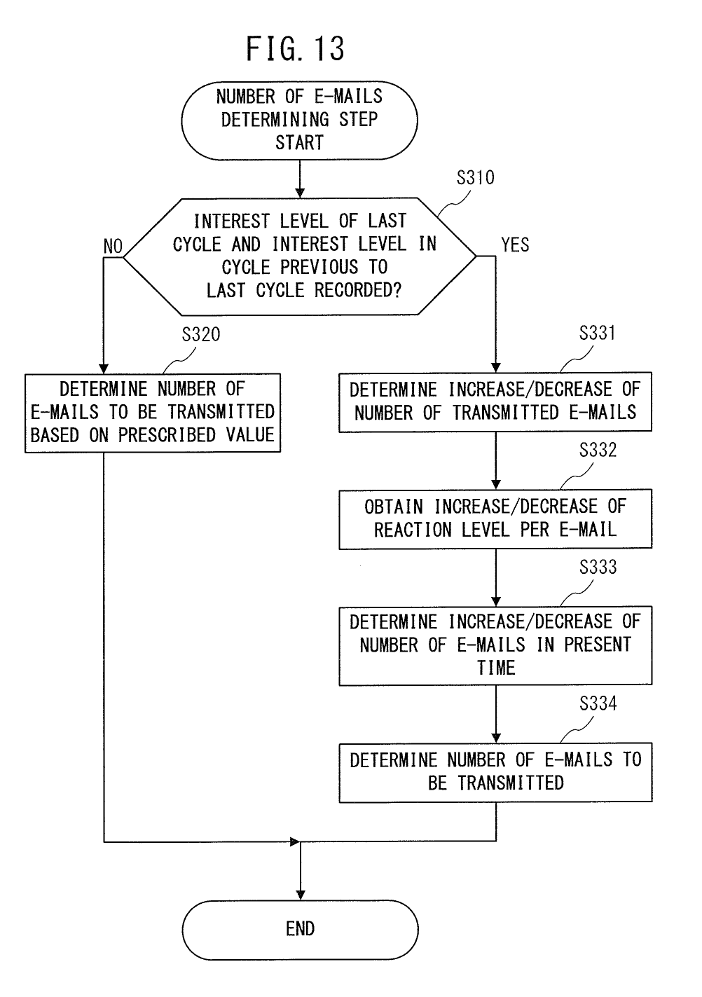

The electronic mail transmitting device 300 determines, in the number of e-mails determining step S10 illustrated in FIG. 13, the number of e-mails so as to maximize the expectation value in the reaction level of the user to the-mail to be transmitted to the user.

An explanation will now be given below of the number of e-mails determining step S10 according to this embodiment with reference to FIG. 13.

At the beginning of the number of e-mails determining step S10, the controller 110 refers to the interest level history table, and determines (step S310) whether or not the interest level of the user in the last cycle and the interest level of the user in the cycle previous to the last cycle are recorded in such a table.

When determining that the interest level of the user in the last cycle and the interest level of the user in the cycle previous to the last cycle are not recorded (step S310: NO), since sufficient past records of the reaction level have not been accumulated yet, the controller 110 determines (step S320) the number of e-mails to be transmitted by adopting a predefined value. When, for example, the interest level in both the last cycle and the cycle previous to the last cycle is not recorded, the controller 110 determines that the number of e-mails to be transmitted is one, and when the interest level in only the last cycle is recorded, the controller determines that the number of e-mails to be transmitted is two.

When, in step S310, determining that the interest level of the user in the last cycle and the interest level of the user in the cycle previous to the last cycle are recorded in the interest level history table (step S310: YES), next, the controller 110 determines (step S331) whether the number of e-mails transmitted in the last cycle increased or decreased in comparison with the cycle previous to the last cycle. More specifically, the controller 110 compares the number of e-mails transmitted in the last cycle with the number of e-mails transmitted in the cycle previous to the last cycle, and determines as “increasing” when the last cycle has the larger number of transmitted e-mails, and determines as “decreasing” when the last cycle has the smaller number of transmitted e-mails.

Next, the controller 110 determines (step S332) whether the reaction level per transmitted e-mail increased or decreased in the last cycle in comparison with the cycle previous to the last cycle. More specifically, the controller 110 compares the reaction level per e-mail in the last cycle with the reaction level per e-mail in the cycle previous to the last cycle, and determines as “increasing” when the last cycle has a larger reaction level per e-mail, determines as “same” when the reaction level in the two cycles is consistent, and determines as “decreasing” when the last cycle has the smaller reaction level per e-mail.

Next, the controller 110 determines (step S333) whether to increase or decrease the number of e-mails to be transmitted in the present contents distributing process in comparison with the last time, or to maintain the same number as the number of e-mails transmitted the last time.

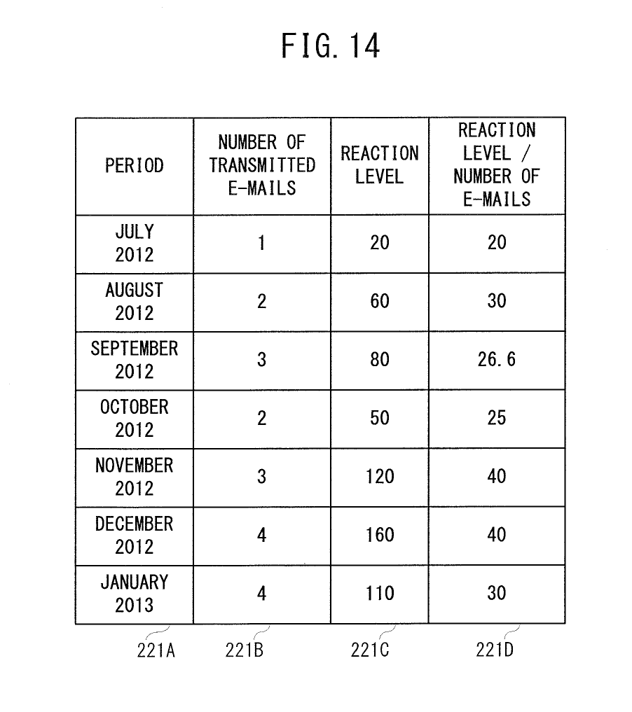

This will be explained more specifically with reference to FIG. 14. FIG. 14 is an explanatory diagram illustrating information recorded in the interest level history table.

As explained above, the interest level history table records the information (221A) indicating the time period in which the behavior history was recorded, the information (221B) indicating the number of e-mails transmitted to the user within the target time period, the information (221C) indicating the reaction level within the target time period, and the information (221D) indicating the ratio of reaction level relative to the number of e-mails transmitted within the target time period (that is, the reaction level per e-mail).

Note that information (221E to G) indicating the interest level to each content within the target time period is omitted in this figure.

When determining in step S331 that the number of e-mails “increased”, and determining in step S332 that the reaction level per e-mail “increased” (for example, from July to August 2012 in the figure), the controller 110 determines to “increase” the number of e-mails. In this case, since the number of e-mails transmitted in the last contents distributing process increased, the reaction level per mail increased. Hence, the controller 110 further increases the number of e-mails to be transmitted presently (for example, September 2012), thereby maximizing the expectation value in the reaction level of the user.

Conversely, when determining in step S331 that the number of e-mails “increased” but determining in step S332 that the reaction level per mail “decreased” (for example, from September to October 2012), since the number of e-mails transmitted in the last contents distributing process increased, the reaction level per e-mail decreased. Hence, the controller 110 determines to “decrease” the number of e-mails (for example, October 2012), thereby maximizing the expectation value in the reaction level of the user.

When determining in step S331 that the number of e-mails “increased”, and determining in step S332 that the reaction level per e-mail was the “same” (for example, from November to December 2012), the controller 110 determines that the number of e-mails to be the “same number”. In this case, since the increase in reaction level per e-mail by increasing the number of e-mails is not expectable anymore, the controller 110 determines that the number of e-mails to be transmitted is to be the same number as the last time (for example, January 2013), and maintains the already maximized expectation value in the reaction level of the user.

When determining in step S331 that the number of e-mails “decreased”, and determining in step S332 that the reaction level per e-mail “increased”, the controller 110 determines to further “decrease” the number of e-mails. In this case, since the number of e-mails transmitted in the last contents distributing process decreased, the reaction level per e-mail increased. Hence, the controller 110 further decreases the number of e-mails to be transmitted presently, thereby maximizing the expectation value in the reaction level of the user.

Conversely, when determining in step S331 that the number of e-mails “decreased” and determining in step S332 that the reaction level per e-mail “decreased” (for example, from September to October 2012), since the number of e-mails transmitted in the last contents distributing process decreased, the reaction level per e-mail decreased. Hence, the controller 110 determines to “increase” the number of e-mails (for example, November 2012), thereby maximizing the expectation value in the reaction level of the user.

When determining in step S331 that the number of e-mails “decreased”, and determining in step S332 that the reaction level per e-mail was the “same”, the controller 110 determines that the number of e-mails to be the “same number”. In this case, since the increase in reaction level per e-mail by decreasing the number of e-mails is not expectable any more, the controller 110 determines that the number of e-mails to be transmitted is to be the same number as the last time, and maintains the already maximized expectation value in the reaction level of the user.

The operation of the controller 110 which has determined in step S331 that the number of e-mails is the “same number” is optional. The controller 110 may perform the same operation as the case when determining that the number of e-mails is to be “increased”.

After step S333, the controller 110 executes the process determined in step S333 on the number of e-mails transmitted in the last contents distributing process, thereby determining (step S334) the number of e-mails to be transmitted in the present contents distributing process. When, for example, three-mails were transmitted in the last contents distributing process, and it is determined in the present step S333 that the number of e-mails is to be “increased”, a value 1 is further added to the last number of transmitted e-mails, and it is determined that a total of four mails are to be transmitted. Conversely, when it is determined in the present step S333 that the number of e-mails is to be “decreased”, a value 1 is subtracted from the last number of transmitted e-mails, and it is determined that a total of two mails are to be transmitted.

When step S320 or step S334 ends, the controller 110 ends the number of e-mails determining step S10. Subsequently, the electronic mail transmitting device 300 executes the same processes as those of the electronic mail transmitting device 200 of the second embodiment, thereby distributing the contents to each user by electronic mail in the determined number.

As explained above, the electronic mail transmitting device 300 tallies up the reaction level of the user after the distribution of the contents, and maximizes the expectation value in the reaction level per e-mail in the next contents distributing process. Hence, the electronic mail transmitting device 300 is capable of further enhancing the advertisement effect in each mail.

The above embodiment is the simplest way of adjusting the number of e-mails to be transmitted, and the number of e-mails to be transmitted within a certain time period is adjustable as needed based on the history of the number of e-mails transmitted in a certain time period and that of the reaction level per e-mail. Hence, as technologies of maximizing the reaction level per e-mail, various maximum-likelihood approaches, interpolation techniques, steepest descend methods are applicable, and since the importance is given to the latest tendency, damping average and weighted average are also applicable. Embodiments to which such various technologies are applied are also within the scope of the present disclosure.

### Fourth Embodiment

An electronic mail transmitting device 400 of this embodiment has a function of transmitting an electronic mail to a credit card user. The electronic mail transmitted by the electronic mail transmitting device 400 includes a transaction details e-mail that describes the transaction amount of the credit card by the credit card user per month, and an advertisement mail that posts a specific advertisement.

In addition, the electronic mail transmitting device 400 may post a specific advertisement to be contained in the advertisement mail on the transaction details e-mail, and transmit such an e-mail instead of transmitting the transaction details e-mail and the advertisement mail separately.

The specific advertisement contained in the advertisement mail or the transaction details e-mail by the electronic mail transmitting device 400 includes an advertisement that proposes the user to change the payment method to an installment payment.

Credit card companies have needs to post an advertisement that proposes a change of payment method to an installment payment on the transaction details e-mail or on the advertisement mail to be transmitted before or after the transaction details e-mail, thereby notifying the user of the proposal. Users sometimes want to change the payment method to the installment payment upon checking the credit card transaction amount in the present month. Hence, by recommending the payment method change to the installment payment, credit card companies can expect the commission income.

Conversely, when the number of advertisement mails to be transmitted becomes too large, as explained above, the possibility that the user does not view the-mails increases, and the resource (for example, network line) consumption over the Internet increases. Credit card companies are likely to effectively advertise a payment method change to the installment payment while avoiding such disadvantages.

The electronic mail transmitting device 400 determines whether or not the probability that the individual credit card user changes the payment method to the installment payment is high based on a predetermined reference. Next, for the user who has a high probability to change the payment method to the installment payment, separately from the transaction details e-mail, the advertisement mail posting the advertisement for the payment method change to the installment payment is transmitted, thereby accomplishing an effective advertisement effect. In contrast, for the user who has a low probability to change the payment method to the installment payment, the transaction details e-mail posting an advertisement for revolving repayment is transmitted, and the transmission of the advertisement mail posting the advertisement for the payment method change to the installment payment is omitted.

As explained above, the electronic mail transmitting device 400 transmits the advertisement mail of changing the payment method to the installment payment only to the users who have a high probability to change the payment method to the installment payment, thereby realizing an effective transmission of advertisement mail.

The electronic mail transmitting device 400 of this embodiment includes, as functions, like the electronic mail transmitting device 100 of the first embodiment, the determiner 101, the classifier 102, the generator 103, and the transmitter 104 as illustrated in FIG. 1. All components are the same as those of the electronic mail transmitting device 100. Hence, the explanation thereof will be omitted.

The electronic mail transmitting device 400 employs the same hardware structure as that of the electronic mail transmitting device 100 of the first embodiment, and includes the controller 110, the storage device 120, the network interface 130, and the inputter 140 and the display 150 as illustrated in FIG. 2. Those structural components are connected to one another via the bus 160. All structural components are the same as those of the electronic mail transmitting device 100, and thus the explanation thereof will be omitted.

In this embodiment, the electronic mail transmitting device 400 determines, based on whether or not the user “utilized the installment payment last month”, the probability of the user to change the payment method to the installment payment. That is, when the user utilized the installment payment last month, the electronic mail transmitting device 400 determines that the probability of this user to change the payment method to the installment payment is high, and transmits, separately from the transaction details e-mail, the advertisement mail posting the advertisement for the payment method change to the installment payment.

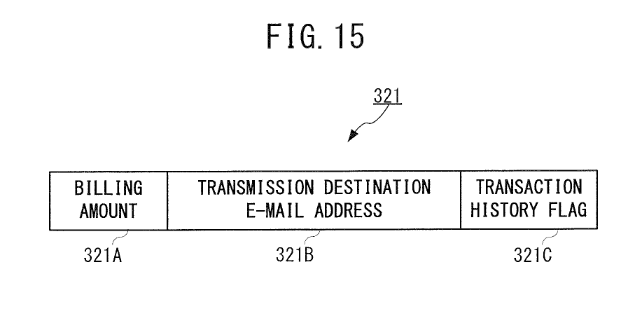

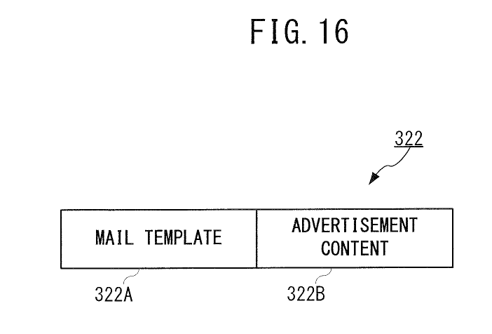

The electronic mail transmitting device 400 includes, in the recorder 202, a credit card user database 321 illustrated in FIG. 15, and a contents database 322 illustrated in FIG. 16.

The credit card user database 321 includes, for each credit card user, an area of recording information indicating the “billing amount” in the present month (billing amount area 321A), an area recording information indicating the transmission-destination e-mail address of the transaction details e-mail (transmission-destination area 321B), and an area recording information indicating “whether or not the credit card user utilized the revolving repayment last month” (transaction history flag 321C) for each credit card user.

The contents database 322 includes an area recording information representing the template of the transaction details e-mail (e-mail template area 322A), and an area recording information for the advertisement (advertisement area 322B).

The e-mail template area 322A records, in the transaction details e-mail, information other than an area showing the actual transaction amount as the template of the transaction details e-mail. The advertisement area 322B records information indicating the advertisement for the payment method change to the installment payment.

The electronic mail transmitting device 400 updates, month by month, information indicating the “billing amount” recorded in the billing amount area 321A for each credit card user. As for the updating of this information, the electronic mail transmitting device 400 may receive information that tallies up the transaction amount of the credit card user in the last month from another device, or may calculate the “billing amount” through another means in the local device.

The electronic mail transmitting device 400 transmits the transaction details e-mail once each month and at a predetermined time point. Prior to the transmission of the transaction details e-mail, the electronic mail transmitting device 400 executes the number of e-mails determining step S10 (illustrated in FIG. 4) explained in the first embodiment.

At the beginning of the number of e-mails determining step S10, the controller 110 obtains (step S110) information indicating the behavior history of the user. More specifically, the controller 110 refers to the transaction history flag 321C in the credit card user database 321, and reads the recorded detail.

Next, the controller 110 determines (step S111) the number of e-mails to be transmitted to the target user. When the information read from the transaction history flag 321C indicates the “change of payment method to the installment payment last month”, the controller 110 determines that the number of e-mails to be transmitted to the target user is two. Conversely, when the information read from the transaction history flag 321C does not record the “change of payment method to the installment payment last month”, the controller 110 determines that the number of e-mails to be transmitted to the target user is one.

The controller 110 records the determined number of e-mails to be transmitted in the area that stores the transmission-destination user information in the storage device 120, and ends the number of e-mails determining step S10.

By executing the above number of e-mails determining step S10, the electronic mail transmitting device 400 determines the number of e-mails to be transmitted. Based on the determined number of e-mails, the electronic mail transmitting device 400 executes the steps subsequent to the number of e-mails determining step S10 (contents classifying step S20, mail creating step S30, and mail transmitting step S40) in the contents distributing process explained in the first embodiment, thereby transmitting the-mails that contain the contents to the target user.

In step S120 of the contents classifying step S20, the controller 110 obtains, from the storage device 120, the contents to be transmitted to the user. In this embodiment, the contents to be transmitted to the user are two that are the “credit card transaction details of the user” and the “advertisement for the change of payment method to installment payment”.

The controller 110 reads the “billing amount” of the target user in the present month from the billing amount area 321A of the credit card user database 321, and combines this information with the information representing the template of the transaction details e-mail recorded in the-mail template area 322A of the contents database 322, thereby obtaining the content that is the “credit card transaction details of the user”. In addition, the controller 110 reads the information indicating the advertisement for the payment method change to the installment payment from the advertisement area 322B of the contents database 322, thereby obtaining the content that is the “advertisement for the payment method change to the installment payment”.

Next, the controller 110 obtains, in step S121, the determined number of e-mails to be transmitted from the area of the storage device 120 which stores the directed user information.

In step S122 of the contents classifying step S20, the controller 110 classifies the contents to be transmitted into respective groups. The contents to be transmitted to the user by the electronic mail transmitting device 400 are two that are the “credit card transaction details of the user” and the “advertisement for the change of payment method to installment payment” as explained above. Hence, when determining that the number of e-mails to be transmitted is one, the controller 110 classifies the “credit card transaction details of the user” and the “advertisement for the change of payment method to installment payment” into one group. In addition, when determining that the number of e-mails to be transmitted is two, the controller 110 classifies the “credit card transaction details of the user” and the “advertisement for the change of payment method to installment payment” into the first group and the second group, respectively. When the classification operation ends, the controller 110 ends the contents classifying step S20.

Subsequent to the contents classifying step S20, the electronic mail transmitting device 400 executes substantially the same processes as those of the electronic mail transmitting device 100 of the first embodiment. That is, the electronic mail transmitting device 400 generates e-mails based on the groups into which the contents are classified through the contents classifying step S20 (mail creating step S30), and transmits the respective generated mails to the transmission-destination e-mail address of the transaction details mail stored in the transmission-destination area 321B of the credit card user database 321 (mail transmitting step S40). Through the above steps, the electronic mail transmitting device 400 ends the contents distributing process.

By adopting such an operation, the electronic mail transmitting device 400 does not transmit the advertisement mail to the user who did not utilize the installment payment last time to suppress the number of e-mails to be transmitted, but is capable of advertising the payment method change to the installment payment in the transaction details e-mail. In addition, to the user who utilized the installment payment last time, the advertisement mail separately from the transaction details e-mail is transmitted to get more attention from that user, thereby accomplishing higher advertisement effect.

In the above example, the electronic mail transmitting device 400 determines the possibility of the user to utilize the installment payment based on only whether or not “the user utilized the installment payment last time”. However, the present disclosure is not limited to this case.

For example, the electronic mail transmitting device 400 may transmit, to the user who has a record of utilizing the installment payment within a predetermined past time period (for example, past 12 months), the advertisement mail separately from the transaction details e-mail. Alternatively, when the credit card transaction amount in the present month sharply increases in comparison with the past transaction amount, or when the credit card transaction amount in the present month exceeds an amount set beforehand, the electronic mail transmitting device 400 may transmit the advertisement mail separately from the transaction details e-mail. The reference to determine the number of e-mails to be transmitted can be set as needed in this way.

The first to fourth embodiments can be combined with one another. The present disclosure can be realized in the form of not only the electronic mail transmitting device that employs the structure to provide the functions of any of the first to third embodiments, but also a system which includes multiple devices and which employs, as a whole system, the structure to provide the functions of any of the first to third embodiments.

The electronic mail transmitting system according to an embodiment of the present disclosure can be realized by not only a dedicated system but also a general computer system. For example, a program that causes a computer to perform the above operations may be distributed in a manner stored in a non-transitory computer readable memory medium, such as a flexible disk, a CD-ROM (Compact Disk-Read Only Memory), a DVD (Digital Versatile Disk) or an MO (Magnet Optical disk), and may be installed in a computer system to construct the electronic mail transmitting system that executes the above processes. In addition, the program may be stored in the disk device or the like of a server device on the Internet, and may be downloaded to a computer in a manner, for example, superimposed on carrier waves.

The foregoing describes some example embodiments for explanatory purposes. Although the foregoing discussion has presented specific embodiments, persons skilled in the art will recognize that changes may be made in form and detail without departing from the broader spirit and scope of the invention.

Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

100, 200, 300, 400 Electronic mail transmitting device
101 Determiner
102 Classifier
103 Generator
104 Transmitter
110 Controller
111 CPU
112 ROM
113 RAM
120 Storage device
130 Network interface
140 Inputter
150 Display
201 Calculator
202 Recorder

1. A transmitting device including a processor and a memory which stores a program executable for the processor, the program comprising:
a determining code that causes the processor to determine, based on a behavior history of a user, a number of e-mails to be transmitted to the user within a predetermined time period;
a classifying code that causes the processor to classify a plurality of contents to be distributed to the user within the predetermined time period to groups of the number of e-mails determined by the determining unit;
a generating code that causes the processor to generate, for each of the groups that are classified the plurality of contents by the classifying unit, an e-mail from the content classified into the groups; and
a transmitting code that causes the processor to transmit the e-mail generated for each of the groups to the user within the predetermined time period.

2. The transmitting device according to claim 1, the program further comprising a that causes the processor to calculate, based on the behavior history of the user, an interest level of the user to a provider of the content,
wherein the generating code causes the processor to set a transmission originator of the e-mail generated for each of the groups to be the provider with a highest calculated interest level among providers of the contents classified into the respective groups.

3. The transmitting device according to claim 2, wherein the creating code causes the processor to arrange, in the e-mail generated for each of the groups, the contents classified into each of the groups in an order of the higher calculated interest level to the providers of the contents classified into the respective groups.

4. The transmitting device according to claim 3, wherein the classifying code causes the processor to select, by what corresponds to the determined number, the providers with a higher ranking calculated interest level among the providers of the contents, and classifies the contents of the selected provider so as not to be redundant with one another into the groups by what corresponds to the determined number.

5. The transmitting device according to claim 2, wherein the interest level is calculated based on a viewing behavior of the user who views a website managed by the provider of the contents within a threshold time period after the content is distributed to the user.

6. The transmitting device according to claim 2, wherein the interest level is calculated based on a purchasing behavior of the user who purchases a product or a service from the provider of the contents within a threshold time period after the content is distributed to the user.

7. The transmitting device according to claim 2, wherein:
the calculating code further causes the processor to calculate a reaction level of the user to the e-mail based on the interest level calculated for the provider of the content contained in the e-mail transmitted to the user; and
the determining code causes the processor to determine the number of e-mails so as to maximize an expectation value in the reaction level of the user to the e-mail to be transmitted to the user.

8. The transmitting device according to claim 2, the program further comprising a recording code that causes the processor to record the behavior history of the user, wherein:
the determining code causes the processor to determine the number of e-mails to be transmitted to the user within the predetermined time period; and
the calculates the interest level of the user to each of the providers of the contents based on the behavior history of the user recorded in the recorder.

9. A transmitting method performed by a transmitting device, the method comprising:
causing the transmitting device to determine, based on a behavior history of a user, a number of e-mails to be transmitted to the user within a predetermined time period;
causing the transmitting device to classify a plurality of contents to be distributed to the user within the predetermined time period to groups of the determined number of e-mails;
causing the transmitting device to generate, for each of the group that are classified a plurality of contents classified, an e-mail from the content classified into the groups; and
causing the transmitting device to transmit the e-mail generated for each of the groups to the user within the predetermined time period.

10. A non-transitory computer readable information recording medium having stored therein a program that causes a computer to function as:
a determiner that determines, based on a behavior history of a user, a number of e-mails to be transmitted to the user within a predetermined time period;
a classifier that classifies a plurality of contents to be distributed to the user within the predetermined time period to groups of the number of e-mails determined by the determiner;
a generator that generates, for each of the groups that are classified a plurality of contents by classifier, an e-mail from the content classified into the groups; and
a transmitter that transmits the e-mail generated for each of the groups to the user within the predetermined time period.

11. (canceled)
